(19) United States
(12) Patent Application Publication
(10) Pub. No.: US 2026/0016300 A1
(43) Pub. Date: Jan. 15, 2026

(54) SYSTEM AND METHOD FOR OFFLINE CALIBRATION OF A MOTION-TRACKING DEVICE

(71) Applicant: Google LLC, Mountain View, CA (US)

(72) Inventors: Hao Wu, San Francisco, CA (US); Zhiheng Jia, Sunnyvale, CA (US); Qiyue Zhang, Santa Clara, CA (US); Chao Guo, Los Altos, CA (US)

(21) Appl. No.: 19/129,521

(22) PCT Filed: Nov. 21, 2022
(86) PCT No.: PCT/US2022/080230

§ 371 Date: May 13, 2025

(51) Int. Cl. G01C 21/16; G01C 25/00

(52) U.S. Cl. CPC G01C 21/183; G01C 21/1656; G01C 25/00

(57) ABSTRACT

Offline calibration of an inertial measurement unit (IMU) can determine biases in the motions measured by the IMU while it is not in use. The offline calibration uses an expected motion measurement based on a motionless IMU as a reference from which the biases can be computed for a temperature. The bias and the temperature can be stored in a thermal table that can be updated and expanded over multiple calibration sessions to include the biases for a range of temperatures. A model relating the biases to temperature may be created based on the thermal table. For example, a curve-fit equation relating the bias as a function of temperature may be computed based on the values in the thermal table.

### FIELD OF THE DISCLOSURE

The present disclosure relates to a device that includes a position sensor for motion tracking, and more specifically, to a method for calibrating the position sensor during periods of inactivity.

### BACKGROUND

A mobile computing device can be configured to measure and track its motion using an inertial measurement unit (IMU). The IMU includes three gyroscopes configured to measure angular rates (i.e., rotations) in three dimensions and may further include three accelerometers configured to measure linear accelerations in three dimensions based on a force exerted by gravity. The three rotations and the three accelerations may be used to track motion with six degrees of freedom (6DOF). For example, the IMU may help track the motion of a head-worn device to enable an augmented reality (AR) experience or virtual reality (VR) experience, and the accuracy of the motion tracking may correspond to the realism of this experience.

### SUMMARY

An IMU in a motion-tracking device may include errors in its measurements that can affect motion tracking. These errors may be represented as a bias that is added to the ideal measurement for each dimension (e.g., X, Y, Z) of the IMU. These biases may vary with temperature in ways that are unique for each device. The present disclosure describes methods and devices that can generate/update a calibration model (i.e., model) while the motion-tracking device is not in use (i.e., idle, offline) in order to characterize the biases. In particular, an offline calibration can collect IMU measurements while the IMU is in a stationary state (i.e., idle state) to determine its biases at one or more temperatures. These measurements can help generate/update a model that relates biases of the IMU to temperatures. When the motion tracking returns to use (i.e., not idle, online), the model can then be used to correct the IMU measurements, which can make the motion tracking more accurate. This offline calibration may be repeated for subsequent idle periods to expand and refine the model over time.

In some aspects, the techniques described herein relate to a method including: detecting an idle state of an inertial measurement unit (IMU); capturing a first motion measurement of the IMU while the IMU is in the idle state, the first motion measurement including a first bias; measuring a temperature of the IMU associated with (i.e., corresponding to) the first motion measurement; computing an estimated bias of the first motion measurement for the measured temperature based on an expected result of the motion measurement of the IMU in the idle state; updating a model based on the estimated bias for the temperature, the model relating biases of the IMU to temperatures of the IMU; capturing a second motion measurement of the IMU while the IMU is not in the idle state, the second motion measurement including a second bias, and using the model to reduce the second bias in the second motion measurement.

In some aspects, the techniques described herein relate to a motion-tracking device including: an inertial measurement unit (IMU) including a gyroscope configured to capture rotation measurements of the motion-tracking device; a temperature sensor configured to measure a temperature of the gyroscope; and a processor configured by software instructions recalled from a memory to: detect that the motion-tracking device is in an idle state; capture a rotation measurement at a temperature of the gyroscope while the motion-tracking device is in the idle state; record an estimated bias of the rotation measurement at the temperature based on an expected result of the rotation measurement for the motion-tracking device in the idle state; and update a model to include the estimated bias of the rotation measurement at the temperature.

In some aspects, the techniques described herein relate to a motion-tracking device including: an inertial measurement unit (IMU) including an accelerometer configured to capture acceleration measurements of the motion-tracking device; a temperature sensor configured to measure a temperature of the accelerometer; and a processor configured by software instructions recalled from a memory to: capture a first acceleration measurement at a first temperature of the accelerometer while the motion-tracking device is in an idle state; execute a process to change the first temperature of the accelerometer to a second temperature while the motion-tracking device is in the idle state; capture a second acceleration measurement at the second temperature while the motion-tracking device is in the idle state; compute an estimated accelerometer bias change from the first temperature to the second temperature; and update a model stored in the memory based on the estimated accelerometer bias change with temperature.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a system block diagram of a motion-tracking device according to a possible implementation of the present disclosure.

FIG. 2 is a system block diagram of an IMU according to a possible implementation of the present disclosure.

FIG. 3 is a perspective view of a motion-tracking device implemented as AR glasses according to a possible implementation of the present disclosure.

FIG. 4 is a flow chart of a method to update a model relating biases to temperatures according to an implementation of the present disclosure.

FIG. 5 is a flow chart for motion tracking according to a possible implementation of the present disclosure.

The components in the drawings are not necessarily to scale relative to each other. Like reference numerals designate corresponding parts throughout the several views.

### DETAILED DESCRIPTION

Motion tracking, such as in an AR device, may have an accuracy that is negatively affected by biases on an IMU used to sense the position and orientation of the AR device. The biases may be difficult to calibrate because they can change with temperature and are not the same for all AR devices. The present disclosure describes a method for generating a model (or models) to compensate for these biases. Based on a temperature, the model may output a bias-estimate that can be used to correct an IMU motion measurement. The model may be generated while the IMU is in an idle state. The idle state may be defined as the physical condition in which no motion of the IMU is detected (e.g., the IMU is stationary). When the IMU is integrated with a device, the idle state may further refer to the physical condition in which no motion of the device is detected (e.g., the device is stationary).

Another technical problem facing this approach is that the model may change over time and this change is not easy to understand because it may differ based on the particular device and its use over time. The present disclosure describes a calibration method that can update the model over time to maintain its accuracy in estimating the bias and does so while the AR device is idle. This may advantageously not interfere with the use of the device and can simplify the calibration when the idle device is stationary. In the following, some example implementations of the disclosure are described.

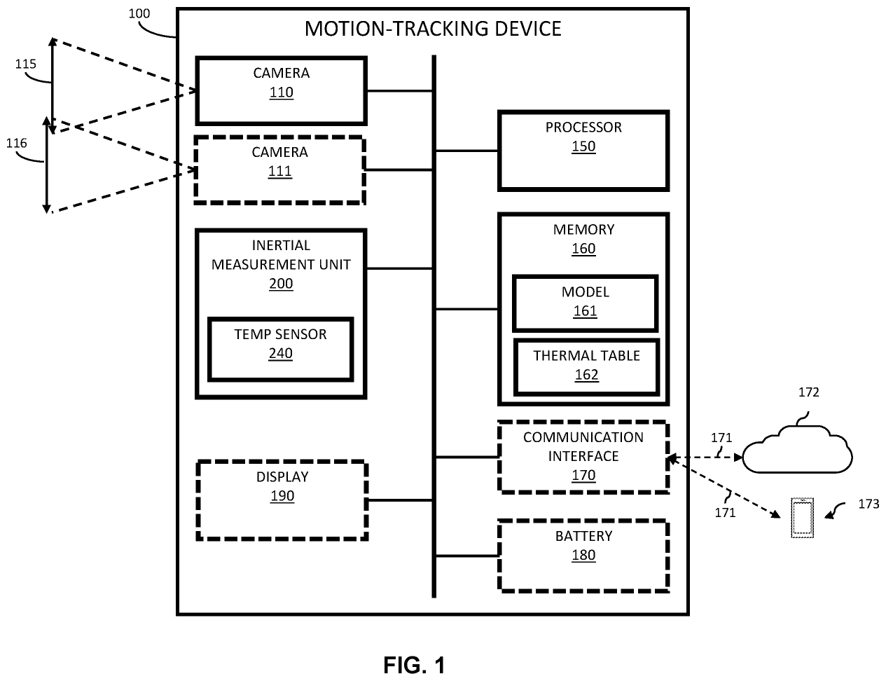

FIG. 1 is a block diagram of a motion-tracking device according to a possible implementation of the present disclosure. The motion-tracking device 100 includes a camera (e.g., first camera 110) configured to capture images of a field-of-view (e.g., first field-of-view 115). The motion-tracking device may further include a processor 150, and images from the first camera 110 may be analyzed by the processor to identify one or more features in the images for motion tracking. Tracking pixel positions of the one or more features over consecutive images may help to determine a motion (e.g., rotation) of the motion-tracking device 100. For example, the camera 110 may be configured to collect a plurality of images over a period. A processor 150 of the motion-tracking device may be configured to analyze the images to determine if the motion-tracking device is stationary/moving and/or how long the motion-tracking device has been stationary/moving. In a possible implementation, an idle state (i.e., stationary state) of the motion-tracking device 100 may be detected when no movement is detected in the images for a period (e.g., longer than a threshold period).

In a possible implementation, the motion-tracking device 100 further includes a second camera 111 configured to capture images of a second field-of-view 116, which may overlap a portion of the first field-of-view 115. The cameras may be aligned and focused so that a first image (e.g., right image) of the first field-of-view and a second image (e.g., left image) of the second field-of-view may be combined to form a stereoscopic image. The stereoscopic images may help to track the one or more features in three dimensions.

The motion-tracking device 100 further includes an inertial measurement unit (i.e., IMU). The IMU can include a plurality of sensors that are aligned with a reference coordinate system having three dimensions (i.e., X, Y, Z). An IMU of a device may be configured to track its changes in position/orientation (i.e., track its motion) with respect to each of the three dimensions. The IMU measurement can be combined with the camera measurement described previously to help track the movement of the motion-tracking device. This form of motion tracking may be referred to as visual inertial odometry (VIO).

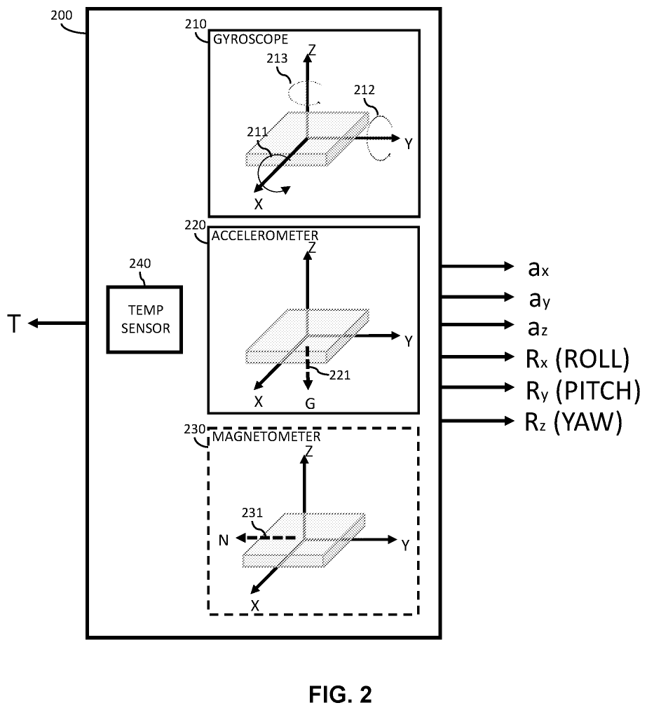

FIG. 2 is a system block diagram of an IMU for a motion-tracking device, such as shown in FIG. 1. The IMU 200 may output a motion measurement having six components (i.e., 6 degrees of freedom) including a first acceleration in an x-direction (i.e., aₓ), a second acceleration in a y-direction (i.e., a_{y}), a third acceleration in a z-direction (i.e., a_{z}), a first rotation (i.e., Rₓ) about an x-axis (ROLL), a second rotation (i.e., R_{y}) around a y-axis (PITCH), and a third rotation (i.e., R_{z}) around a z-axis (YAW). The six components are relative to a coordinate system (X, Y, Z) that may be aligned with, or define, a coordinate system of the motion-tracking device.

The IMU 200 may include a gyroscope module 210 including an X-axis gyroscope configured to measure the first rotation 211 (i.e., ROLL) around an X-axis of the coordinate system; a Y-axis gyroscope configured to measure the second rotation 212 (i.e., PITCH) around a Y-axis of the coordinate system; and a Z-axis gyroscope configured to measure the third rotation 213 (i.e., YAW) around a Z-axis of the coordinate system associated with the motion-tracking device. Accordingly, the rotations measured by the gyroscope module 210 may be used in motion tracking (e.g., navigation) to measure change in the orientation of a motion tracking device.

A gyroscope of the IMU 200 may be implemented as a micro-electromechanical system (MEMS) in which a movement of a mass affixed to springs can be capacitively sensed to determine rotation. The alignment of the mass and the springs can determine the axis of the sensed rotation. Accordingly, the IMU 200 may include three MEMS gyroscopes, each aligned to sense a corresponding rotation around an axis of the coordinate system.

Each gyroscope may be configured to measure a rotation measurement, such as the angular rate of rotation around the axis of the gyroscope. Ideally, when a gyroscope is stationary its measured angular rate will be zero. In practice, a magnitude of a rotation measured by a stationary (i.e., idle state) gyroscope may be very small. For example, an expected motion measurement (i.e., expected rotation) of a gyroscope in an idle state may have a magnitude corresponding to the Earth's rotation (e.g., 15 degrees per hour) or less (e.g., zero). A gyroscope bias is an offset above this very small rotation (e.g., zero) that is added by imperfections in the gyroscope, such as mechanical deviations (from design) of the spring/mass of the MEMS capacitive sensor from design. These mechanical deviations are subject to change according to thermal conditions, and as a result, a gyro bias may change according to temperature.

Estimating a bias of a rotation measurement (i.e., estimating a gyro bias) may include determining an expected rotation measurement of the stationary gyroscope (e.g., R_{expect}=0), as illustrated in the equation below.

$${R}_{meas} ( {T}_{1} ) = R + bias ( {T}_{1} ) \qquad ( 1 )$$

In the equation above “Rₘₑₐₛ” is the measured rotation at the temperature (T1). In the equation above, R is the rotation of the gyroscope, which is expected to be zero or a small value corresponding to the Earth's rotation while the gyroscope is in the idle state (i.e., stationary). Accordingly, while in the idle state, the estimated bias of the rotation measurement at the temperature can be computed (and recorded) as the difference between the rotation measurement (Rₘₑₐₛ) and the expected rotation measurement (R).

The IMU 200 may further include an accelerometer module 220 that includes an X-axis accelerometer configured to measure a first acceleration (i.e., aₓ) in an X-direction; a Y-axis accelerometer configured to measure a second acceleration (i.e., a_{y}) in a Y-direction; and a Z-axis accelerometer configured to measure a third acceleration (i.e., a_{z}) in a Z-direction.

An accelerometer module 220 of the IMU 200 may be implemented as a MEMS configured to capacitively sense a force (e.g., gravity 221) exerted on a movable mass to determine an acceleration. The accelerometer may effectively sense velocity or displacement by processing (e.g., integrated) the acceleration over time. For example, a measured acceleration (i.e., minus gravity) may be integrated once to compute velocity and may be integrated twice to compute a position. Accordingly, the acceleration measured by the accelerometer module 220 may be used in motion tracking (e.g., navigation) to measure change in the acceleration, velocity, or position of a motion tracking device.

Ideally, when an accelerometer is stationary its measured acceleration will be approximately gravity. In practice, a bias (i.e., offset) is added to the approximately gravity measurement of the stationary (i.e., idle) accelerometer. The bias can result from imperfections in the accelerometer, such as mechanical deviations (from design) of the movable of the MEMS sensor from design. These mechanical deviations are subject to change according to thermal conditions, and as a result, an accelerometer bias may change according to temperature.

Estimating an accelerometer bias may include determining an expected measurement of the stationary accelerometer that accounts for a direction of gravity 221 relative to a coordinate system of the accelerometer module 220. When the orientation of the accelerometer relative to gravity is unknown it may not be possible to determine an absolute bias; however, it may still be possible to a relative change in the accelerometer bias with temperature, as illustrated in the equations below.

$${a}_{meas} ( {T}_{1} ) = a ( G ) + bias ( {T}_{1} ) \qquad ( 2 )$$

$${a}_{meas} ( {T}_{2} ) = a ( G ) + bias ( {T}_{2} ) \qquad ( 3 )$$

In the equations above, aₘₑₐₛ is the measured acceleration at temperature (T₁, T₂), “a” is the expected acceleration, which is a function of (i.e., depends on) gravity, “G”. In the idle state, the expected acceleration is constant. If the temperature is changed while in the idle state, the accelerometer is stationary and effects of gravity (G) are constant. Accordingly, the estimated accelerometer bias change (Δ_{bias}) from the first temperature (T₁) to the second temperature (T₂) can be computed as the difference in the measured accelerations at the temperatures.

The mechanical nature of the MEMS sensors described above can make their responses sensitive to changes in temperature and/or to changes in their installed environment. For example, a temperature change or a force due to use (or misuse) of the motion-tracking device can alter the sensitivity of the MEMS devices. For example, dropping or bending the motion-tracking device can cause a change in the installed environment, thereby changing a response of a gyroscope or an accelerometer of the IMU.

As mentioned above, the bias may be a function of temperature (i.e., bias (T)). Accordingly, the IMU 200 may be configured to output a temperature (T) from a temperature sensor 240. The temperature can approximate (e.g., within a degree Celsius) a temperature of the gyroscope module 210 and the accelerometer module 220. Accordingly, the IMU 200 may be configured to output a motion measurement (e.g., rotation measurement, acceleration measurement) that includes a bias and may be further configured to output (e.g., output simultaneously) a temperature corresponding to the motion measurement (i.e., corresponding to the bias).

In a possible implementation the temperature sensor 240 is not included as part of the IMU 200 but rather is included in the motion-tracking device 100 on, or near, the IMU 200 so as to measure a temperature (T) that corresponds to the temperature of the gyroscope module 210 and the accelerometer module 220.

In a possible implementation, the IMU 200 can further include a magnetometer 230 that includes an X-axis magnetometer configured to measure a first magnetic field strength (i.e., Hₓ) an X-direction of the coordinate system, a Y-axis magnetometer configured to measure a second magnetic field strength (i.e., H_{y}) in a Y-direction of the coordinate system, and a Z-axis magnetometer configured to measure a third magnetic field strength (i.e., H_{z}) in a Z-direction of the coordinate system. The magnetic field strengths may be relative to the Earth's magnetic field 231 (i.e., north (N)).

Returning to FIG. 1, the motion-tracking device 100 further includes a memory 160. The memory may be a non-transitory computer-readable medium and may be configured to store instructions that, when executed by the processor 150, can configure the motion tracking device to perform the disclosed methods. For example, the memory 160 may be configured to store the model 161 related to the estimated bias to the temperature. The memory may be further configured to store a thermal table 162 that can be used with the mode, as will be described below.

The motion-tracking device 100 may further include a display 190. For example, the display 190. In a possible implementation, the display 190 is a heads-up display (i.e., HUD). The motion-tracking device 100 may further include a battery 180. The battery 180 may be configured to provide energy to the subsystems, modules, and devices of the motion-tracking device 100 to enable their operation. The battery 180 may be rechargeable and have an operating life (e.g., lifetime) between charges. Accordingly, the processor 150 may be configured to execute (i.e., run) a process to charge the battery (i.e., battery-charging process).

The battery-charging process may indicate (to the processor 150) that the motion-tracking device is idle. For example, if battery charging continues for a period after reaching full (100%) charge, then the motion-tracking device may be considered to in an idle state. The battery-charging process may also raise a temperature of the motion-tracking device. The battery-charging process may also indicate (to the processor) that power consumption can be increased. In response, a processor may execute a computing process with a high processing load to increase a temperature of the processor, which may be used to increase a temperature of the IMU 200. In a possible implementation the computing process may be adjusted to increase or decrease a processing load (i.e., load) on the processor to control the temperature of the IMU 200.

The motion-tracking device 100 may further include a communication interface 170. The communication interface may be configured to communicate information digitally over a wireless communication link 171 (e.g., WiFi, Bluetooth, etc.). For example, the motion-tracking device may be communicatively coupled to a network 172 (i.e., the cloud) or a device (e.g., mobile phone 173) over the wireless communication link 171. The wireless communication link may allow operations of a computer-implemented method to be divided between devices and/or could allow for remote storage of the model 161 and/or the thermal table 162. The motion-tracking device may be used for augmented reality (AR) or virtual reality (VR).

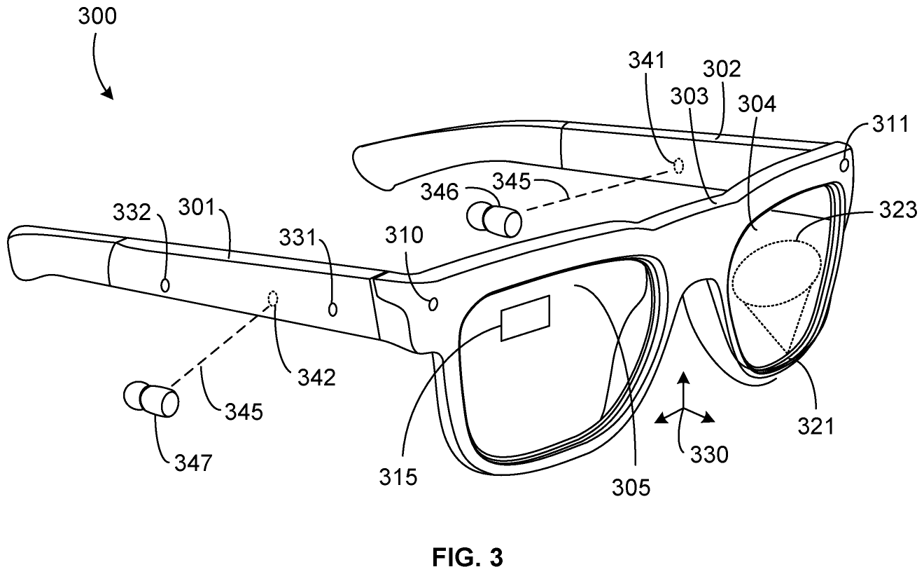

FIG. 3 is a perspective view of an implementation of the motion-tracking device. The motion-tracking device may be smart glasses configured for augmented reality (i.e., augmented reality glasses). The AR glasses 300 can be configured to be worn on a head and face of a user. The AR glasses 300 include a right earpiece 301 and a left earpiece 302 that are supported by the ears of a user. The AR glasses further include a bridge portion 303 that is supported by the nose of the user so that a left lens 304 and a right lens 305 can be positioned in front a left eye of the user and a right eye of the user respectively. The portions of the AR glasses can be collectively referred to as the frame of the AR glasses. The frame of the AR glasses can contain electronics to enable function. For example, the frame may include a battery, a processor, a memory (e.g., non-transitory computer readable medium), electronics to support sensors (e.g., cameras, depth sensors, etc.), at least one position sensor (e.g., an inertial measurement unit) and interface devices (e.g., speakers, display, network adapter, etc.). The AR glasses may display and sense an environment relative to a coordinate system 330. The coordinate system 330 can be aligned with the head of a user wearing the AR glasses. For example, the eyes of the user may be along a line in a horizontal (e.g., x-direction) direction of the coordinate system 330.

A user wearing the AR glasses can experience information displayed in an area corresponding to the lens (or lenses) so that the user can view virtual elements within their natural field of view. Accordingly, the AR glasses 300 can further include a heads-up display (i.e., HUD) configured to display visual information at a lens (or lenses) of the AR glasses. As shown, the heads-up display may present AR data (e.g., images, graphics, text, icons, etc.) on a portion 315 of a lens (or lenses) of the AR glasses so that a user may view the AR data as the user looks through a lens of the AR glasses. In this way, the AR data can overlap with the user's view of the environment. In a possible implementation, the portion 315 can correspond to (i.e., substantially match) area(s) of the right lens 305 and/or left lens 304.

The AR glasses 300 can include an IMU that is configured to track motion of the head of a user wearing the AR glasses. The IMU may be disposed within the frame of the AR glasses and aligned with the coordinate system 330 of the AR glasses 300.

The AR glasses 300 can include a first camera 310 that is directed to a first camera field-of-view that overlaps with the natural field-of-view of the eyes of the user when the glasses are worn. In other words, the first camera 310 can capture images of a view aligned with a point-of-view (POV) of a user (i.e., an egocentric view of the user).

In a possible implementation, the AR glasses 300 can further include a second camera 311 that is directed to a second camera field-of-view that overlaps with the natural field-of-view of the eyes of a user when the glasses are worn. The second camera 311 and the first camera 310 may be configured to capture stereoscopic images of the field of view of the user that includes depth information about objects in the field of view of the user. The depth information may be generated using visual odometry and used as part of the camera measurement corresponding to the motion of the motion-tracking device.

In a possible implementation, the AR glasses may further include a depth-sensor configured to capture a depth image corresponding to the field-of-view of the user. The depth image includes pixels having pixel values that correspond to depths (ranges) to objects measured at positions corresponding to the pixel positions in the depth image.

The AR glasses 300 can further include an eye-tracking sensor. The eye tracking sensor can include a right-eye camera and/or a left-eye camera 321. As shown, a left-eye camera 321 can be located in a portion of the frame so that a left FOV 323 of the left-eye camera 321 includes the left eye of the user when the AR glasses are worn.

The AR glasses 300 can further include one or more microphones. The one or more microphones can be spaced apart on the frames of the AR glasses. As shown in FIG. 3, the AR glasses can include a first microphone 331 and a second microphone 332. The microphones may be configured to operate together as a microphone array. The microphone array can be configured to apply sound localization to determine directions of the sounds relative to the AR glasses.

The AR glasses may further include a left speaker 341 and a right speaker 342 configured to transmit audio to the user. Additionally, or alternatively, transmitting audio to a user may include transmitting the audio over a wireless communication link 345 to a listening device (e.g., hearing aid, earbud, etc.). For example, the AR glasses may transmit audio to a left wireless earbud 346 and to a right earbud 347.

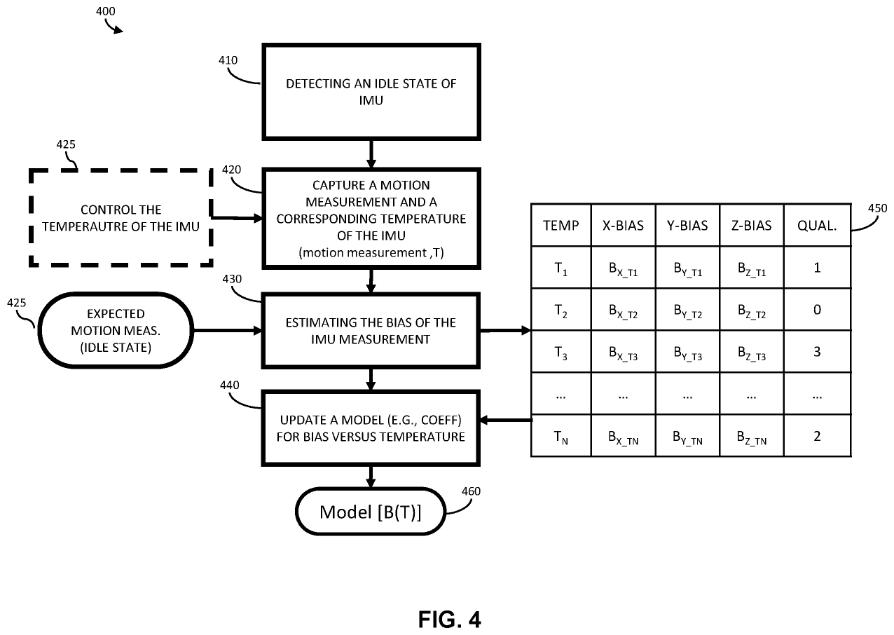

FIG. 4 is a flow chart of a method to compute an estimated bias for a temperature to update a model relating biases to temperatures. The method 400 includes detecting 410 an idle state of the IMU. In other words, the method includes detecting that the IMU is stationary and likely to remain stationary for a period necessary to update the model. In some implementations the idle state must be continuously maintained for a period to be detected (i.e., must be persistent).

In one possible implementation, the IMU is part of a motion-tracking device and detecting that the IMU is in an idle state includes detecting 410 that the motion-tracking device is executing a battery-charging process (i.e., is charging). This detection may further include determining that the motion-tracking device has been charging for a period greater than a threshold period.

In another possible implementation, the IMU is part of a motion-tracking device including a camera and detecting 410 that the IMU is in an idle state includes detecting no motion based on images captured by the camera. For example, the camera may capture a plurality of images over a period and may process the images to determine that the motion-tracking device has been stationary for the period.

In another possible implementation, detecting 410 that the IMU is in an idle state includes detecting no motion based on IMU measurements collected by the IMU. For example, the IMU may capture a plurality of measurements (e.g., accelerometer measurements, gyroscope measurements, magnetometer measurements) over a period and may process the measurements to determine that the motion-tracking device has been stationary for the period.

The present disclosure is not limited to these particular implementations for detecting 410 that the IMU is in an idle state. Other means for detecting idle periods may exist for example a time of day may be used to determine an idle state of the IMU. For example, an idle state may be scheduled by a user or otherwise determined based on a schedule of a user.

As shown in FIG. 4, the method 400 further includes capturing 420 a motion measurement from the IMU and a corresponding temperature of the IMU. The motion measurement may be a rotation around an axis (e.g., Rx, Ry, or Rz) or can be an acceleration along an axis (e.g., ax, ay, or az) and may be repeated for any one motion/axis, any group of motions/axes, or all motions/axes of the IMU (e.g., see FIG. 2). Each motion measurement has a corresponding measured temperature. Accordingly, capturing the motion measurement may include storing the motion measurement and the temperature as a related pair (e.g. [a_{x,y,or z}, T] or [R_{x,y, or z}, T]) in a memory (e.g., database).

In a possible implementation, the method 400 may optionally include controlling 425 the temperature of the IMU so that a motion measurement can be captured at a particular temperature or at a plurality of temperatures in a range of temperatures. The particular temperature may be determined based on a requirement for the model. For example, the model may wish to represent biases in a range of temperatures (e.g., 5≤range≤20 degrees Celsius). Accordingly, it may be desirable to capture motion measurements for a set of temperatures in the range during one or more periods of inactivity. Controlling the temperature may ensure that all temperatures in the set of temperatures are captured over time. The temperature of the IMU may be controlled using various methods.

In one possible implementation, controlling 425 the temperature of the IMU may include using the battery-charging process to control the temperature of the IMU. For example, a current supplied to the battery for charging can be increased to raise a temperature of the IMU and decreased to lower a temperature of the IMU. The current supplied to the battery may also be modulated (ON/OFF) to maintain the temperature of the IMU. Even without direct control over the battery-charging process, the battery-charging process may raise a temperature of the IMU. Accordingly, in a possible implementation, the method 400 may include monitoring the rise in the temperature during the charging process and capturing a motion measurement when the monitored temperature reaches some particular temperature or is within some temperature range.

In another possible implementation, controlling 425 the temperature of the IMU may include running a computing process. The computing process may be made computationally complex in order to increase a processing load (e.g., processing time) of the processor of the motion-tracking device, which can increase a temperature of the IMU (indirectly). For example, a processing load of the computing process may be increased to increase the temperature of the IMU, and the processing load of the computing process may be decreased to decrease the temperature of the IMU. Alternatively, the processing load of the computing process may be activated to increase the temperature of the IMU and deactivated to decrease a temperature of the IMU. Accordingly, in a possible implementation, a duty cycle of the computing process may be used to regulate the temperature of the IMU.

As shown in FIG. 4, the method 400 may further include estimating 430 the bias for the measured temperature (i.e., computing an estimated bias) based on an expected measurement of the IMU (i.e., expected motion measurement) in the idle state. The expected measurement may correspond to no motion of the IMU. For a rotation measurement, the lack of motion of the IMU may be measured as zero rotation or as a small rotation due to the rotation of the earth. For example, the expected measurement of the IMU in the idle state may be a rotation having a magnitude between zero and a magnitude corresponding to the Earth's rotation (i.e., 0≤R≤R_{Earth}). The estimated bias for the measured temperature may be recorded in a thermal table 450 stored in a memory.

The thermal table 450 can store estimated biases and temperatures. For example, the thermal table 450 can include rows that each include a temperature (i.e., T1), a first estimated bias in an x-dimension (i.e., B_{X_T1})), a second estimated bias in a y-dimension (i.e., B_{Y_T1})), a third estimated bias in a z-dimension (i.e., B_{Z_T1})), and a quality (i.e., QUAL).

The quality may correspond to a number of times that the biases for the temperature have been updated. The quality of biases interpolated from other measurements may be zero. For example, the quality of a row having biases interpolated from neighboring rows may be zero. The quality may correspond to how many data points in a given time period (e.g., 24 hours) are used to create the estimate of the biases. The quality may be used to weigh an average used to determine a bias.

Estimating a bias for a temperature may include interpolating bias values from values in the thermal table 450. For example, a spline (e.g., cubic spline) interpolation may be fit to the bias values in the thermal table 450. In another implementation, a least squares solution may be fit to the bias values in the thermal table. The quality factors in the thermal table 450 may be used to select a fitting technique used to determine a bias for a temperature from values in the thermal table. For example, when the quality is less than a threshold (e.g., 10), then a least square fit may be used, otherwise a spline interpretation may be used.

The values stored in the thermal table 450 may be accumulated over successive repetitions of the method 400. In other words, the biases stored in the thermal table may be measured at different times (i.e., during different idle states). One advantage of this approach is that the data used for the thermal model may be acquired over time. Accordingly, the model may change with time (e.g., improve with time). For example, idle states may be detected over successive nights and the biases estimated each night may be at the same or different temperatures. When biases are estimated for the same temperature, they can be combined (e.g., averaged).

The method may further include updating 440 a model 460 (e.g., coefficients) based on biases in the thermal table 450. For example, coefficients of a cubic spline may be determined to so that a piecewise curve (e.g., Bₓ(T)=aᵢ+bᵢT+cᵢT²+dᵢT³, where i is the piece of the spline) passes through all the bias/temperatures of the thermal table. The resulting model 460 (e.g., Bx(T), By(T), Bz(T)) for the gyroscopes and/or accelerometers may be stored locally on an internal of the device or may be stored remotely on a memory in communication with the device (e.g., over a network). Over time the model may adapt as new estimates of the biases are acquired. This adaptation may include averaging coefficients of a model created at a first time with a coefficient of a model created at a second time.

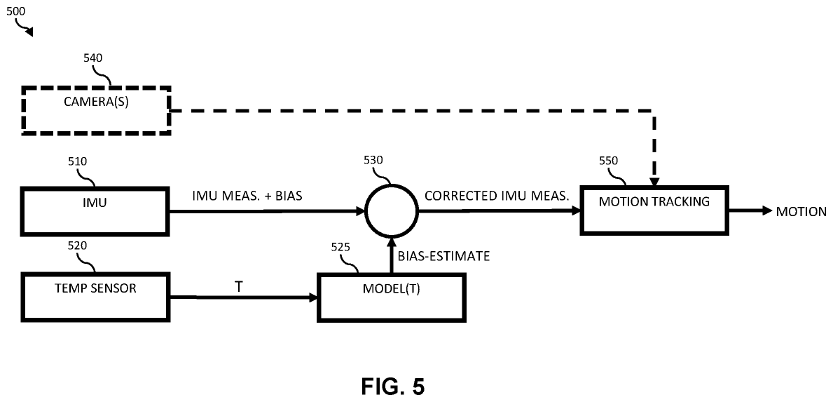

FIG. 5 is a flow chart for motion tracking that includes reducing a bias in a motion measurement collected by an IMU 510 of a motion-tracking device (e.g., AR glasses, mobile phone, tablet, etc.) while the IMU is not in an idle state (i.e., in an active state). As shown, the motion measurement with a reduced bias (i.e., corrected IMU measurement) may be used by a motion-tracking process 550 to detect a motion. The method 500 includes capturing a motion (e.g., rotation, acceleration) measurement from an IMU 510 corresponding to a motion of the motion-tracking device. The IMU measurement includes a bias corresponding to a difference between the actual motion of the IMU and the IMU's measurement of the motion.

The method 500 further includes measuring a temperature (T) of the IMU. As described previously, the temperature may be measured using a temperature sensor 520, which can be included as a module of the IMU. The temperature (T) may be input to a model 525 (e.g., equation) used to compute a bias-estimate of the IMU for the temperature (T). For example, the model 530 may be an equation (or equations) relating bias-estimate to the temperature (i.e., model (T)-bias-estimate). A processor of the motion-tracking device may recall the model 525 from a memory of the device and apply the temperature (T) to the model to calculate the bias-estimate.

The method 500 further includes applying 530 the bias-estimate to the IMU measurement including the bias to generate a corrected IMU measurement. For example, the bias-estimate may be subtracted from the IMU measurement to reduce or eliminate the bias from the IMU measurement. The corrected IMU measurement may include position/orientation changes described by 6DOF. Accordingly, the corrected IMU measurement may be applied to motion tracking process 550 to determine a motion of the IMU (e.g., motion of the motion-tracking device).

In a possible implementation, the method 500 optionally includes capturing a plurality of images using at least one camera 540 of the motion tracking device. The images captured by the at least one camera can be used to help the motion tracking process 550. For example, the images may be a sequence of images in a video stream. The sequence of images may include a first image collected (i.e., captured) at a first time and a second image collected (i.e., captured) at a second time. The first image and the second image can be analyzed 540 to compare features (e.g., recognized points, lines, shapes in the image) to compute a camera measurement corresponding to the motion of the device based on the comparison. The camera measurement may include position/orientation changes described by 6DOF, which can be used with the corrected IMU measurement to determine a motion of the motion-tracking device.

In the following, some examples of the disclosure are described.

Example 1. A method including detecting an idle state of an inertial measurement unit (IMU); capturing a first motion measurement of the IMU while the IMU is in the idle state, the first motion measurement including a first bias; measuring a temperature of the IMU associated with the first motion measurement (i.e., the temperature of the IMU during the first motion measurement); computing an estimated bias of the first motion measurement for the measured temperature based on an expected result of the motion measurement of the IMU in the idle state; updating a model based on the estimated bias for the temperature, the model relating biases of the IMU to temperatures of the IMU; capturing a second motion measurement of the IMU while the IMU is not in the idle state, the second motion measurement including a second bias, and using the model to reduce the second bias in the second motion measurement.

Example 2. The method as in Example 1, where the IMU is included in a motion-tracking device configured for motion-tracking using the model to reduce the second bias on the second motion measurement.

Example 3. The method as in Example 2, further including configuring the motion-tracking device to control the temperature of the IMU corresponding to the first motion measurement using a battery-charging process.

Example 4. The method as in Example 3, where detecting the idle state of the IMU includes: determining that the motion-tracking device has been executing the battery-charging process for a period greater than a threshold period.

Example 5. The method as in any of Examples 2 through 4, further including configuring the motion-tracking device to control the temperature of the IMU associated with the first motion measurement using a computing process.

Example 6. The method as in any of Examples 2 through 5, where detecting the idle state of the IMU includes collecting a plurality of images over a period using a camera included in the motion-tracking device; and determining from the plurality of images to that the motion-tracking device is stationary for the period.

Example 7. The method as in any of the preceding Examples, where detecting the idle state of the IMU includes collecting a plurality of measurements of the IMU over a period; and determining from the plurality of measurements that the IMU is stationary for the period.

Example 8. The method as in any of the preceding Examples, where the first motion measurement and the second motion measurement are captured by a gyroscope of the IMU.

Example 9. The method as in any of the preceding Examples, where the expected result of the motion measurement of the IMU in the idle state is a rotation having a magnitude corresponding to an Earth's rotation or less.

Example 10. The method as in any of the preceding Examples, where the idle state is a first idle state, the temperature is a first temperature, the estimated bias is a first estimated bias, and the method further includes: detecting a second idle state of the IMU; capturing a third motion measurement of the IMU while the IMU is in the second idle state, the third motion measurement including a third bias; measuring a second temperature of the IMU associated with (i.e., corresponding to) the third motion measurement; computing a second estimated bias of the third motion measurement for the second temperature based on the expected result of the third motion measurement of the IMU in the idle state; and updating the model based on the second estimated bias for the second temperature, the model relating biases of the IMU to temperatures of the IMU.

Example 11. The method as in Example 10, where the first idle state occurs during a first night; and the second idle state occurs during a second night, subsequent to the first night.

Example 12. The method as in Example 10 or 11, further including recording the first estimated bias of the first motion measurement for the first temperature and the second estimated bias of the third motion measurement for the second temperature in a thermal table including estimated biases and temperatures accumulated over time.

Example 13. The method as in Example 12, further including computing coefficients of a curve fit to the estimated biases and temperatures accumulated over time.

Example 14. The method as in Examples 12 or 13, where the temperatures accumulated over time span a temperature range of between 5 and 20 degrees.

Example 15. A motion-tracking device that includes an inertial measurement unit (IMU) including a gyroscope configured to capture rotation measurements of the motion-tracking device; a temperature sensor configured to measure a temperature of the gyroscope; and a processor. The processor is configured by software instructions recalled from a memory to detect that the motion-tracking device is in an idle state; capture a rotation measurement at a temperature of the gyroscope while the motion-tracking device is in the idle state; record an estimated bias of the rotation measurement at the temperature based on an expected result of the rotation measurement for the motion-tracking device in the idle state; and update a model to include the estimated bias of the rotation measurement at the temperature.

Example 16. The motion-tracking device as in Example 15, where the idle state is a first idle state, the rotation measurement is a first rotation measurement, the temperature is a first temperature, and the estimated bias is a first estimated bias. The processor is further configured to detect that the motion-tracking device is in a second idle state, the second idle state subsequent to the first idle state; capture a second rotation measurement at a second temperature of the gyroscope while the motion-tracking device is in the second idle state; record a second estimated bias of the second rotation measurement at the second temperature based on the expected result of the rotation measurement for the motion-tracking device in the idle state; and update the model to include: the first estimated bias at the first temperature recorded during the first idle state; and the second estimated bias at the second temperature recorded during the second idle state.

Example 17. The motion-tracking device as in Examples 15 or 16, where the processor is further configured by software instructions recalled from the memory to apply the model to rotation measurements of the motion-tracking device during motion tracking to reduce an inaccuracy due to a gyroscope bias.

Example 18. A motion-tracking device that includes an inertial measurement unit (IMU) including an accelerometer configured to capture acceleration measurements of the motion-tracking device; a temperature sensor configured to measure a temperature of the accelerometer; and a processor. The processor is configured by software instructions recalled from a memory to capture a first acceleration measurement at a first temperature of the accelerometer while the motion-tracking device is in an idle state; execute a process to change the first temperature of the accelerometer to a second temperature while the motion-tracking device is in the idle state; capture a second acceleration measurement at the second temperature while the motion-tracking device is in the idle state; compute an estimated accelerometer bias change from the first temperature to the second temperature; and update a model stored in the memory based on the estimated accelerometer bias change with temperature.

Example 19. The motion-tracking device as in Example 18, where the process to change the first temperature of the accelerometer to the second temperature is a battery-charging process.

Example 20. The motion-tracking device as in Examples 18 or 19, where the process to change the first temperature of the accelerometer to the second temperature is a computing process configured to increase a load on the processor.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

1-20. (canceled)

21. A method comprising:
detecting an idle state of a motion sensor;
capturing a first motion measurement of the motion sensor while the motion sensor is in the idle state;
measuring a temperature of the motion sensor, the temperature associated with the first motion measurement;
estimating a first bias of the first motion measurement for the temperature based on a second motion measurement, which is expected for the motion sensor in the idle state; and
updating a model based on the first bias for the temperature, the model relating biases of the motion sensor to temperatures of the motion sensor.

22. The method according to claim 21, wherein the motion sensor is included in a motion-measuring device, the motion-measuring device configured for motion-measurements using the model to reduce the biases of the motion-measurements.

23. The method according to claim 22, further comprising:
configuring the motion-measuring device to control the temperature of the motion sensor, while capturing the first motion measurement, using a battery-charging process.

24. The method according to claim 23, further including:
detecting that the motion sensor is in the idle state by determining that the motion-measuring device has been executing the battery-charging process for a period greater than a threshold period.

25. The method according to claim 22, further comprising:
configuring the motion-measuring device to control the temperature of the motion sensor, while capturing the first motion measurement, using a computing process.

26. The method according to claim 22, further including detecting that the motion sensor is in the idle state by:
collecting a plurality of images over a period using a camera included in the motion-measuring device; and
determining from the plurality of images that the motion-measuring device is stationary for the period.

27. The method according to claim 21, further including detecting that the motion sensor is in the idle state by:
collecting a plurality of measurements of the motion sensor over a period; and
determining from the plurality of measurements that the motion sensor is stationary for the period.

28. The method according to claim 21, wherein the first motion measurement is captured by a gyroscope of an inertial measurement unit.

29. The method according to claim 28, wherein the second motion measurement, which is expected for the motion sensor in the idle state, is a rotation having a magnitude less than or equal to the rotation of the Earth.

30. The method according to claim 21, wherein the idle state is a first idle state, and the temperature is a first temperature, the method further including:
detecting a second idle state of the motion sensor;
capturing a third motion measurement of the motion sensor while the motion sensor is in the second idle state;
measuring a second temperature of the motion sensor associated with the third motion measurement;
estimating a second bias of the third motion measurement for the second temperature based a fourth motion measurement, which is expected for the motion sensor in the second idle state; and
updating the model based on the second bias for the second temperature.

31. The method according to claim 30, wherein:
the first idle state occurs during a first night; and
the second idle state occurs during a second night, subsequent to the first night.

32. The method according to claim 30, further including:
recording the first bias for the first temperature and the second bias for the second temperature in a thermal table to accumulate the biases and the temperatures over time.

33. The method according to claim 32, further including:
computing coefficients of a curve fit to the biases and the temperatures accumulated over time.

34. The method according to claim 32, wherein:
the temperatures accumulated over time span a temperature range of between 5 and 20 degrees.

35. A mobile computing device including:
an inertial measurement unit (IMU) including a gyroscope configured to capture rotation measurements of the mobile computing device;
a temperature sensor configured to measure a temperature of the gyroscope; and
a processor configured by software instructions recalled from a memory to:
detect that the mobile computing device is in an idle state;
capture a first rotation measurement while the mobile computing device is in the idle state;
receive the temperature of the gyroscope, the temperature associated with the first rotation measurement
estimate a first bias of the first rotation measurement at the temperature based on a second rotation measurement, which is expected for the mobile computing device in the idle state; and
update a model based on the first bias for the temperature, the model relating biases of the gyroscope to temperatures of the gyroscope.

36. The mobile computing device according to claim 35, wherein the idle state is a first idle state and the temperature is a first temperature, wherein the processor is further configured to:
detect a second idle state of the mobile computing device;
capture a third rotation measurement of the gyroscope while the mobile computing device is in the second idle state;
receiving a second temperature of the gyroscope associated with the third rotation measurement;
estimating a second bias of the third rotation measurement at the second temperature based on a fourth rotation measurement, which is expected for the mobile computing device in the idle state; and
update the model based on the second bias for the second temperature.

37. The mobile computing device according to claim 35, wherein the processor is further configured by the software instructions recalled from the memory to:
apply the model to the rotation measurements of the mobile computing device while the mobile computing device is not in the idle state to reduce the biases in the rotation measurements.

38. A mobile computing device including:
an inertial measurement unit (IMU) including an accelerometer configured to capture acceleration measurements of the mobile computing device;
a temperature sensor configured to measure a first temperature of the accelerometer; and
a processor configured by software instructions recalled from a memory to:
capture a first acceleration measurement while the mobile computing device is in an idle state;
receive the first temperature of the accelerometer, the first temperature associated with the first acceleration measurement;
execute a process to change the first temperature of the accelerometer to a second temperature while the mobile computing device is in the idle state;
capture a second acceleration measurement at the second temperature while the mobile computing device is in the idle state;
compute a change in bias from the first temperature to the second temperature based on the first acceleration measurement and the second acceleration measurement; and
update a model stored in the memory based on the change in the bias

39. The mobile computing device according to claim 38, wherein the process is a battery-charging process.

40. The mobile computing device according to claim 38, wherein the process is a computing process configured to increase a load on the processor.
